(19) United States
(12) Patent Application Publication
(10) Pub. No.: US 2015/0209879 A1
(43) Pub. Date: Jul. 30, 2015

(54) EXTENSION SUPPORT FOR CUTTING SAW

(71) Applicant: Rexon Industrial Corp., Ltd., Taichung (TW)

(72) Inventor: Jung-Huo CHEN, Taichung (TW)

(73) Assignee: Rexon Industrial Corp., Ltd., Taichung (TW)

(21) Appl. No.: 14/608,599

(22) Filed: Jan. 29, 2015

(30) Foreign Application Priority Data
Jan. 29, 2014 (TW) 103103537

(51) Int. Cl. B23D 47/02; B23D 45/04

(52) U.S. Cl. CPC B23D 47/02; B23D 45/044

(57) ABSTRACT

An extension support for a cutting saw includes two supporting units connectable to a worktable and convertible between a first configuration and a second configuration. Each supporting unit includes a linking member, and a supporting bracket affixed to a distal end of the linking member. In the first configuration, the supporting units are respectively connected to two opposite lateral sides of the worktable. In the second configuration, the two supporting units are connected to each other, the linking member of one supporting unit is connected to one of an opposing first end and second end of the worktable, and the supporting bracket of the supporting unit that is connected to the worktable is adapted for accommodating the linking member of the other supporting unit. Thus, the length of the extension support can be adjusted to fit different lengths of workpieces.

### FIELD OF THE INVENTION

The present invention relates to machine tool technology, and more particularly to an extension support for a cutting saw.

### BACKGROUND

Referring to FIG. 1 (Taiwan Patent Application Publication No. 201321121), a prior art cutting saw is shown comprising a worktable 1, a cutting unit 2 connected to one lateral side of the worktable 1, and two supporting brackets 3 respectively connected to the two opposite lateral sides of the worktable 1. Each supporting bracket 3 comprises a pair of linking members 301 connected to the worktable 1, and a supporting member 302 located at respective distal ends of the linking members 301.

When cutting a long workpiece, supporting members 302 of the two supporting brackets 3 are pulled outwardly from the worktable 1 in reversed directions to adjust the combined length of the two supporting brackets 3 to extend the supporting area for giving a full and stable support to the workpiece.

The aforesaid prior art cutting saw has widely been used. However, when cutting a relatively longer workpiece to obtain a relatively shorter finished product, the supporting bracket at the side facing toward the finished product will be unable to give a full and stable support to the finished product, and the support rendered by the other supporting bracket will be insufficient for holding the workpiece in position.

### SUMMARY OF THE INVENTION

The present invention has been accomplished under the circumstances in view. It is therefore the main object of the present invention to provide an extension support for a cutting saw, which fits different lengths of workpieces and provides a full and stable support to the workpiece to be cut.

To achieve this and other objects of the present invention, an extension support is used in a cutting saw comprising a worktable defining opposing first and second ends and a top wall extended from the first end to the second end. The extension support comprises two supporting units connectable to the worktable. Each supporting unit comprises at least one linking member, and a supporting bracket fixedly connected to a distal end of each linking member. The supporting bracket comprises a top wall fitting the supporting wall, and at least one connection portion respectively disposed adjacent to the at least one linking member. The two supporting units are convertible between a first configuration where the two supporting units are respectively disposed at two opposite lateral sides relative to the worktable and the linking members of the two supporting units are respectively connected to the first end and second end of the worktable, and a second configuration where the at least one linking member of one supporting unit is connected to one of the first end and second end of the worktable and the at least one linking member of the other supporting unit is connected to the at least one connection portion of the supporting unit that is connected to the first end of the worktable.

The present invention has the following effects: mounting the two supporting units at the two opposite lateral sides of the worktable can give a full and stable support to any of a variety of different lengths of workpieces and the finished product; and connecting the two supporting units in series at one lateral side of the worktable can give a full and stable support to a relatively longer workpiece.

### BRIEF DESCRIPTION OF THE DRAWINGS

Other advantages and features of the present invention will be understood by reference to the following specification in conjunction with the accompanying drawings, in which like reference characters denote like elements of structure.

FIG. 1 is an oblique top elevational view of a cutting saw according to the prior art.

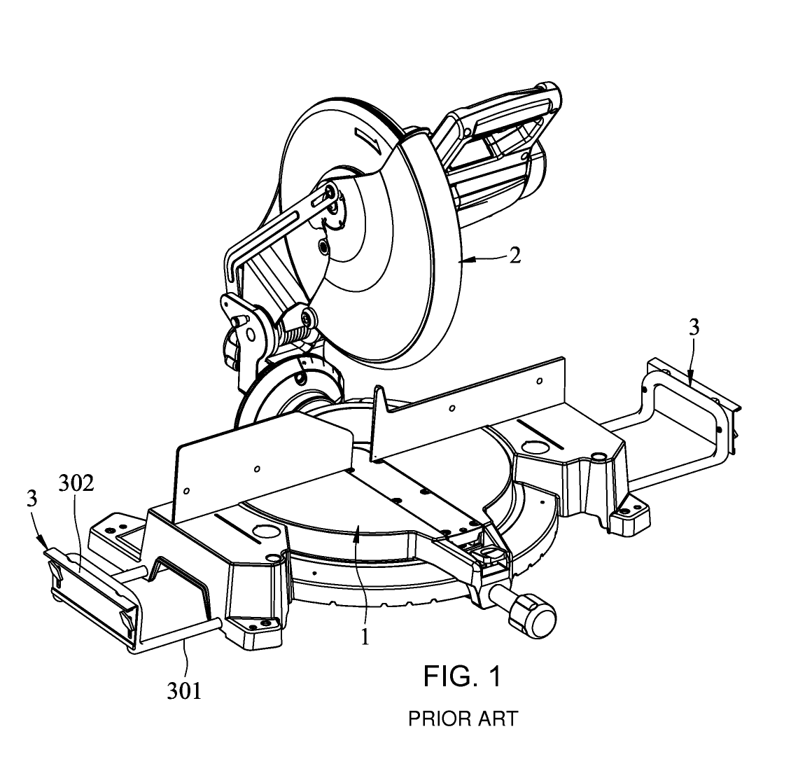

FIG. 2 illustrates an extension support used in a cutting saw in accordance with the present invention.

FIG. 3 is an enlarged view of a part of FIG. 2, illustrating the extension support in the first configuration.

FIG. 4 is similar to FIG. 2, illustrating the extension support in the second configuration.

FIG. 5 is an enlarged view of a part of FIG. 4.

FIG. 6 is a schematic drawing of a part of the present invention, illustrating the length of one supporting unit adjusted.

It should be noted that the drawing figures are not necessarily drawn to scale, but instead are drawn to provide a better understanding of the components thereof, and are not intended to be limiting in scope, but rather to provide exemplary illustrations. It should further be noted that the figures illustrate exemplary embodiments of the present invention and the components thereof, and in no way limits the structures, configurations and components thereof according to the present disclosure.

### DETAILED DESCRIPTION

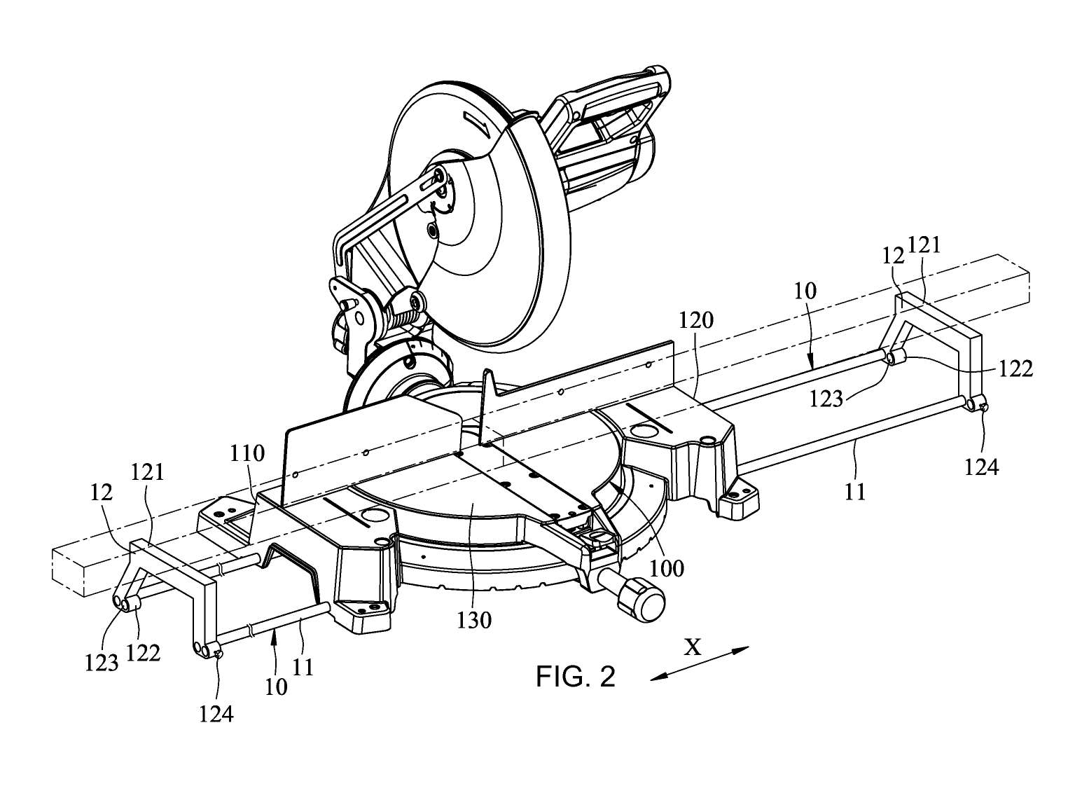

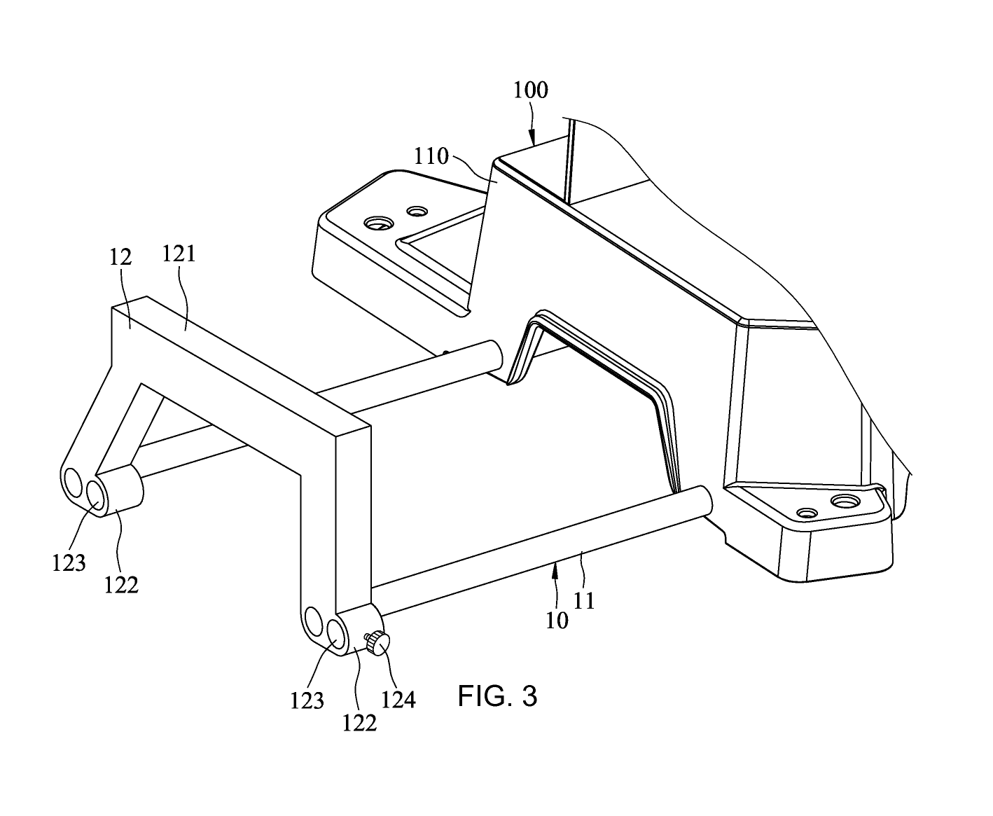

Referring to FIGS. 2 and 3, an extension support in accordance with the present invention is shown installed in a cutting saw. The cutting saw comprises a worktable 100. The worktable 100 comprises opposing first end 110 and second end 120 arranged along a transverse direction X, and a top wall 130 extended from the first end 110 to the second end 120. The extension support comprises two supporting units 10.

The two supporting units 10 are connectable to the worktable 100, each comprising two linking members 11, and a supporting bracket 12 affixed to respective distal ends of the linking members 11. The linking members 11 extend along the transverse direction X between the first end 110 and the second end 120 for working as a sliding guide rail.

Each supporting bracket 12 comprises a supporting wall 121 fitting the top wall 130, two connection portions 122 bilaterally located at a bottom side thereof and respectively disposed adjacent to the linking members 11, and a locking member 124 mounted in one connection portion 122. In this embodiment, the locking member 124 is a locking knob. However, screw bolt, quick release, etc. can be selectively used as a substitute. The connection portions 122 have a hollow structure, each defining therein a through hole 123 that extends in a direction corresponding to the length of the linking members 11. The locking member 124 can be driven into the through hole 123 of the associating connection portion 122. The linking members 11 of each supporting unit 10 and the connection portions 122 of the associating supporting bracket 12 are arranged in parallel in a staggered manner. Further, the distance between the center points of the two linking members 11 of each supporting unit 10 is substantially equal to the distance between the center points of the two connection portions 122 of the associating supporting bracket 12.

Referring to FIGS. 2 and 3 again, the supporting units 10 are convertible between a first configuration and a second configuration. When in the first configuration, the supporting units 10 are respectively disposed at two opposite lateral sides relative to the worktable 100, and the linking members 11 of the supporting units 10 are respectively connected to the first end 110 and second end 120 of the worktable 100. At this time, the supporting unit 10 at the first end 110 can be used to support a workpiece for cutting, and the supporting unit 10 at the second end 120 can be used to support the workpiece to be cut or the finished product after cutting. Further, by means of moving the linking members 11 of the supporting units 10 relative to the first end 110 and second end 120 of the worktable 100, the combined length of the supporting units 10 is relatively adjusted to fit different lengths of workpieces or finished products, and the workpiece to be cut or the finished product produced after cutting can get full support.

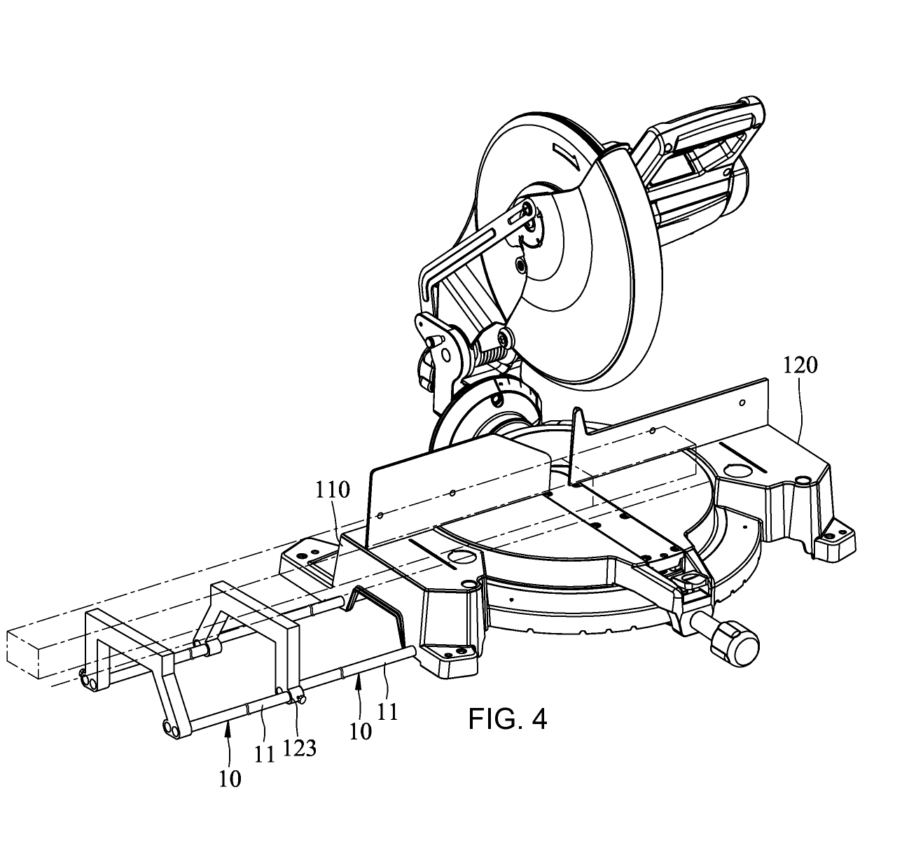

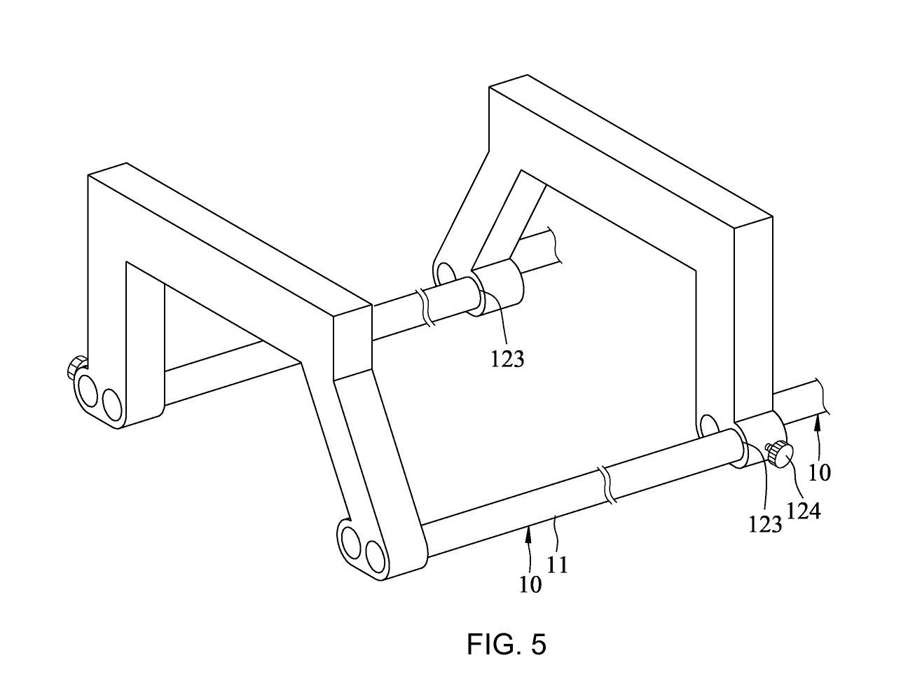

Referring to FIG. 4 and FIG. 5, the supporting units 10 are shown in the second configuration. Converting the supporting units 10 into the second configuration is achieved by detaching the supporting unit 10 from the second end 120 of the worktable 100 and then connecting the detached supporting unit 10 to the supporting unit 10 at the first end 110 of the worktable 100. For example, the linking members 11 of one supporting unit 10 is connected to the first end 110 of the worktable 100 with the connection portions 122 thereof adapted for the insertion of the linking members 11 of the other supporting unit 10 in a slidably adjustable manner. After insertion of the linking members 11 of the other supporting unit 10 into the respective connection portions 122 of the supporting unit 10 at the first end 110 of the worktable 100, the locking member 124 of the other supporting unit 10 is fastened tight to lock the two supporting units 10 in position.

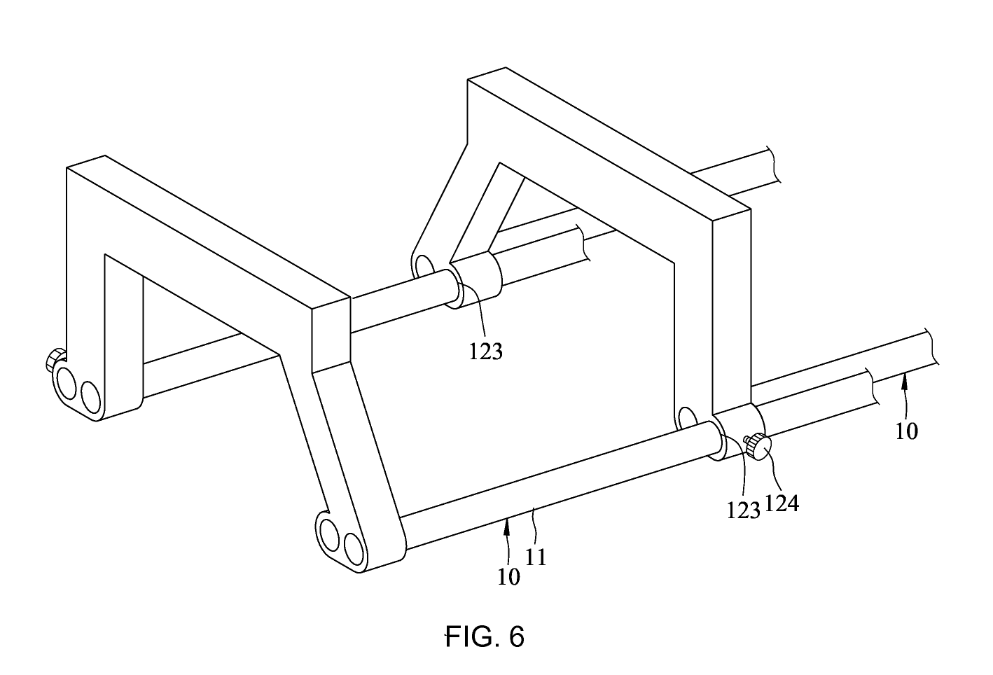

After the two supporting units 10 are connected in series along the transverse direction X, they can give a full and stable support to a relatively longer workpiece for cutting and a relatively shorted finished product that is obtained after a cutting operation. Further, by means of slidably inserting the at least one linking member 11 of one supporting unit 10 into the at least one connection portion 122 of the other supporting unit 10 to adjustably connect the two supporting units 10 together, and by means of moving the at least one linking member 11 of the supporting unit 10 being connected to the first end 110 of the worktable 100 in and out of the first end 110, the combined supporting length of the supporting units 10 of the extension support can be adjusted to fit different lengths of workpieces (see FIG. 6), thus achieving a wide range of applications.

It should be appreciated that the invention allows the supporting units 10 to be respectively mounted in the first end 110 and second end 120 of the worktable 100, or connected in series and selectively mounted in the first end 110 or second end 120 of the worktable 100, thus meeting different supporting requirements for supporting different lengths of workpieces and different sizes of finished products. Further, there is no particular restriction on the directionality of the installation of the supporting units 10, and therefore, the composition, number and inventory control of the component parts of the extension support can be simplified.

It should also be appreciated that in the aforesaid embodiment, the linking members 11 and connection portions 122 of each supporting unit 10 are arranged in parallel in a staggered manner. However, if the retractable adjustability of the two supporting units 10 in the connected condition is not taken into account, the supporting units 10 can be so configured that when in the second configuration, the linking members 11 of one supporting unit 10 can be axially connected to the connection portions 122 of the other supporting unit 10, achieving the expected effects.

In conclusion, the extension support for a cutting saw advantageously has a simple structure, has ease of fabrication and installation, and has optimal supporting applicability.

Although particular embodiment of the invention have been described in detail for purposes of illustration, various modifications and enhancements may be made without departing from the spirit and scope of the invention. Accordingly, the invention is not to be limited except as by the appended claims.

What is claimed is:

1. An extension support used in a cutting saw comprising a worktable defining opposing first end and second end and a top wall extended from said first end to said second end, the extension support comprising two supporting units connectable to said worktable, each said supporting unit comprising at least one linking member and a supporting bracket fixedly connected to a distal end of each said linking member, said supporting bracket comprising a supporting wall fitting said top wall and at least one connection portion respectively disposed adjacent to said at least one linking member, said two supporting units being convertible between a first configuration where said two supporting units are respectively disposed at two opposite lateral sides relative to said worktable and the linking members of said two supporting units are respectively connected to said first end and said second end of said worktable, and a second configuration where the at least one linking member of one said supporting unit is connected to one of said first end and said second end of said worktable and the at least one linking member of the other said supporting unit is connected to the at least one connection portion of the supporting unit that is connected to the one of said first end and said second end of said worktable.

2. The extension support as claimed in claim 1, wherein each said supporting unit comprises two said linking members; said supporting bracket of each said supporting unit comprises two said connection portions.

3. The extension support as claimed in claim 2, wherein said linking members of each said supporting unit and said connection portions of the associating said supporting bracket are arranged in parallel in a staggered manner.

4. The extension support as claimed in claim 3, wherein the distance between the center points of the two said linking members of each said supporting unit is substantially equal to the distance between the center points of the two said connection portions of the associating said supporting bracket.

5. The extension support as claimed in claim 4, wherein said connection portions of said supporting bracket of each said supporting unit are hollow members each defining therein a through hole that extends in a direction corresponding to the length of said linking members, the connection portions of one said supporting unit been connected to said first end of said worktable being adapted for slidably adjustably accommodating the linking members of the other said supporting unit.

6. The extension support as claimed in claim 5, wherein said supporting bracket of each said supporting unit further comprises a locking member mounted in one connection portion thereof and drivable into the through hole of the associating said connection portion to lock the linking members of the other said supporting unit to the connection portions that accommodate the linking members of the other said supporting unit.

7. The extension support as claimed in claim 1, wherein said at least one linking member of each said supporting unit extends along a transverse direction between said first end and said second end for working as a sliding guide rail.

8. The extension support as claimed in claim 6, wherein said locking member of each said supporting unit is a locking knob.

9. The extension support as claimed in claim 6, wherein said locking member of each said supporting unit is a quick release device.

10. The extension support as claimed in claim 2, wherein when in said second configuration, the at least one linking member of one said supporting unit is axially slidably coupled to the at least one connection portion of the other said supporting unit.

11. The extension support as claimed in claim 2, wherein said at least one linking member of each said supporting unit extends along a transverse direction between said first end and said second end for working as a sliding guide rail.

12. The extension support as claimed in claim 3, wherein said at least one linking member of each said supporting unit extends along a transverse direction between said first end and said second end for working as a sliding guide rail.

13. The extension support as claimed in claim 4, wherein said at least one linking member of each said supporting unit extends along a transverse direction between said first end and said second end for working as a sliding guide rail.

14. The extension support as claimed in claim 5, wherein said at least one linking member of each said supporting unit extends along a transverse direction between said first end and said second end for working as a sliding guide rail.

15. The extension support as claimed in claim 6, wherein said at least one linking member of each said supporting unit extends along a transverse direction between said first end and said second end for working as a sliding guide rail.
